(19) United States
(12) Patent Application Publication
(10) Pub. No.: US 2019/0278755 A1
(43) Pub. Date: Sep. 12, 2019

(54) COMPUTER INDEXING AND RETRIEVAL OF INSIGHT DATA OBJECTS, SYSTEMS AND METHODS

(71) Applicant: PANDEXIO, INC., Hermosa Beach, CA (US)

(72) Inventors: John Burge, Manhattan Beach, CA (US); Simon Politakis, Rodondo Beach, CA (US); Brandon Varilone, South Lyon, MI (US); Robert Danna, Las Vegas, NV (US); Laci Loew, Las Vegas, NV (US)

(21) Appl. No.: 16/295,848

(22) Filed: Mar. 7, 2019

Related U.S. Application Data
(60) Provisional application No. 62/639,798, filed on Mar. 7, 2018.

(51) Int. Cl. G06F 16/22; G06F 17/27

(52) U.S. Cl. CPC G06F 16/2228; G06F 17/2765

(57) ABSTRACT

In a cooperative insight-sharing system, a method of reducing steps to index and retrieve an insight data object. The cooperative insight-sharing system stores the insight data object in an insight database, and compares insight attributes of the insight data object to known attributes stored in a reference database. Based on the comparison, the cooperative insight-sharing system derives an insight actionability measure, and links the insight actionability measure to the insight data object. The cooperative insight-sharing system generates a measure analysis of the insight actionability measure as a function of the reference database and the insight attributes of the insight data object, and causes an output device to render the measure analysis to a user.

This application claims the benefit of U.S. provisional application No. 62/639,798, entitled “Computer Indexing and Retrieval of Insight Data Objects, Systems and Methods”, filed on Mar. 7, 2018. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is insight indexing and retrieval systems, and more particularly improved computer indexing and retrieval of insight data objects, systems and methods.

### BACKGROUND

The background description includes information that can be useful in understanding the present invention. It is not an admission that any of the information provided herein is prior art or relevant to the presently claimed invention, or that any publication specifically or implicitly referenced is prior art.

Today, very little attention is paid to the indexing and management of worker insights, at least in commercial domains. The majority of worker insights remain in the minds of the workers. To the extent the insights are digitally captured, they are often not indexed, and can be very difficult to find, access and use. Insights are also often mixed in with other written content inside larger documents, and are not recognized as separate, structured information objects. This is a foundational problem for companies and economies seeking to transition to insight-driven operations. The vast majority of insights are generated by workers in response to information they consume. The volume of information that workers must process today is both overwhelming and increasing, and it is increasingly important that organizations get better at indexing worker insights as discrete information objects in a more machine-readable form.

As companies increasingly adopt insight curation systems, they have an increasing need for systems and methods that help workers quickly find the most actionable insights created by others. The degree to which insights are structured and indexed is contemplated to greatly impact the ability to find and leverage the insights for making business decisions, and taking other business-related actions.

Previous efforts in this field include co-owned U.S. Pat. No. 9,613,136 B2 to Burge entitled “Assertion Quality Assessment and Management System”, granted Apr. 4, 2017, which discloses a system for using interaction data by other system users to determine the value of an assertion. However, Burge does not address the problem of improving the recording, indexing, and retrieval of values attributed to a collection of assertions in structured information objects for later referencing by third parties. A Parsimonious Language Model of Social Media Credibility to Mitra et. al discloses use of automated linguistic analysis to evaluate the credibility of Tweets®. As with Burge, Mitra fails to address the problem of improving the recording, indexing, and retrieval of values attributed to a collection of insights.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The following description includes information that can be useful in understanding the present invention. It is not an admission that any of the information provided herein is prior art or relevant to the presently claimed invention, or that any publication specifically or implicitly referenced is prior art.

Accordingly, there is a need for improved computer indexing and retrieval of insight data objects to address the needs of increasingly insight-driven organizations.

### SUMMARY OF THE INVENTION

The inventive subject matter provides for improved computer indexing and retrieval of insight data objects, systems and methods.

In a preferred embodiment, an insight analysis engine is coupled to an insight authoring model that is part of a collaborative insight-sharing system. The collaborative insight-sharing system enables presentation of insight data objects to other users of the collaborative insight-sharing system. Insight data objects are formed by insight authors in response to content sources consumed within the collaborative insight-sharing system. As insight authors consume content sources, they encounter content excerpts which trigger the formation of insight data objects which they record using insight authoring module. Insight data objects can be linked to content excerpts which are linked to content sources. Insight data objects can also exist as parent insight data objects which link to child insight data objects. Basic Data Structure:

Level 3: Content source
Level 2: Content excerpt
   Level 1: Insight (which can further include parent/child insight levels above)

A preferred insight analysis engine uses keyword lookup tables to assess insight data objects, deriving insight actionability measures by executing an algorithm based on the keywords and length of insight data object. The keyword tables can be updated over time based on user feedback on insight actionability measures. An insight guidance agent coupled to insight authoring module provides feedback to insight authors in the form of a measure analysis of insight actionability measure, enabling insight author to revise their insight data object in order to improve insight actionability measure. In some embodiments, insight guidance agent can further provide feedback to insight authors in the form of suggested keywords or missing keywords that would improve insight actionability measure for insight data object. An insight database can then be indexed by insight actionability measures, enabling search results sets to be ordered according to insight actionability measures.

In yet another aspect, the insight analysis engine considers the results of a sentiment analysis in deriving an insight actionability measure. A sentiment analysis can include any emotion-based metric used to derive the insight actionability measure.

It is also contemplated that the insight analysis engine can also consider ontologies and rules-based expert systems. Ontologies, as used herein, can include any set of concepts and categories in a subject area or domain that shows their properties and the relations between the concepts and/or the categories. Rules-based expert systems can include any rules-based system for deriving an insight actionability measure.

In other aspects, insight actionability scores can be used for mapping insight data objects to knowledge levels. This mapping can be performed based on a single content source, a specific insight author, a domain, or across multiple domains for an organization. Additionally, the invention can be used to classify insight data objects by insight type.

Various objects, features, aspects and advantages of the inventive subject matter will become more apparent from the following detailed description of preferred embodiments, along with the accompanying drawing figures in which like numerals represent like components

### BRIEF DESCRIPTION OF THE DRAWINGS

FIG. 1 shows a schematic of a computing system connected to end users through a network

FIG. 2 shows a block diagram of a collaborative insight-sharing system incorporating a computer data management system

FIG. 3 shows content source viewer containing an insight authoring module

FIG. 4 shows an insight data object, including an insight actionability measure

FIG. 5a shows a conceptual diagram of the factors bearing on insight actionability

FIG. 5b shows the nodes and edges of an insight graph reflecting the factors bearing on insight actionability

FIG. 6 provides an example of insight actionability measures for a sampling of insight data objects

FIG. 7 depicts the user interface of an insight authoring module

FIG. 8 shows a measure analysis of an insight actionability measure presented to an insight author

FIG. 9 is a process diagram illustrating processes executed by insight authoring module, insight analysis engine and insight guidance agent

FIG. 10 provides an illustrated example of parent and child insight data object data structures

FIG. 11 depicts an example of a parent insight data object

FIG. 12 represents the assessment components for one potential embodiment of insight analysis engine using keyword lookup tables

FIG. 13a disclosed an algorithm for one embodiment, using keyword lookup tables

FIG. 13b depicts a measure scaling table for converting an absolute score to a scaled score

FIG. 14 depicts the word types used in the embodiment using keyword lookup tables

FIG. 15 depicts an analytical assessment component

FIG. 16 depicts a factual assessment component

FIG. 17 depicts an actionable assessment component

FIG. 18 depicts a contextual assessment component

FIG. 19a depicts an insight authoring module with an illustrative insight data object

FIG. 19b depicts an insight authoring module with suggested and missing words from an insight guidance agent

FIG. 20 depicts a search interface presenting a search results set ordered based on insight actionability measures

FIG. 21 is a process diagram illustrating an insight search process

FIG. 22 depicts data elements in an insight data object

FIG. 23 depicts a weighted score for ordering a search results set

FIG. 24 depicts the classification of insight data objects into knowledge levels based on content source

FIG. 25 depicts the classification of insight data objects into a knowledge level for a domain for specific workers

FIG. 26 depicts the classification of insight data objects into a knowledge level for a domain for a an aggregate grouping of workers

FIG. 27 depicts a knowledge map of insight data objects classified into knowledge levels across a set of domains relevant to an organization

FIG. 28 depicts a user feedback mechanism within a collaborative insight-sharing system

FIG. 29 depicts use of a user feedback mechanism in receiving feedback about an insight actionability measure

FIG. 30 depicts classification of an insight data object into a insight type by an insight analysis engine

FIG. 31 depicts a search interface using insight types to filter a search results set presented to a user

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be noted that the above-described invention relates to a computing system connected to a network. The computing system can include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The computing and network systems which support this invention are more fully described in the patent applications referenced within this application.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention can contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

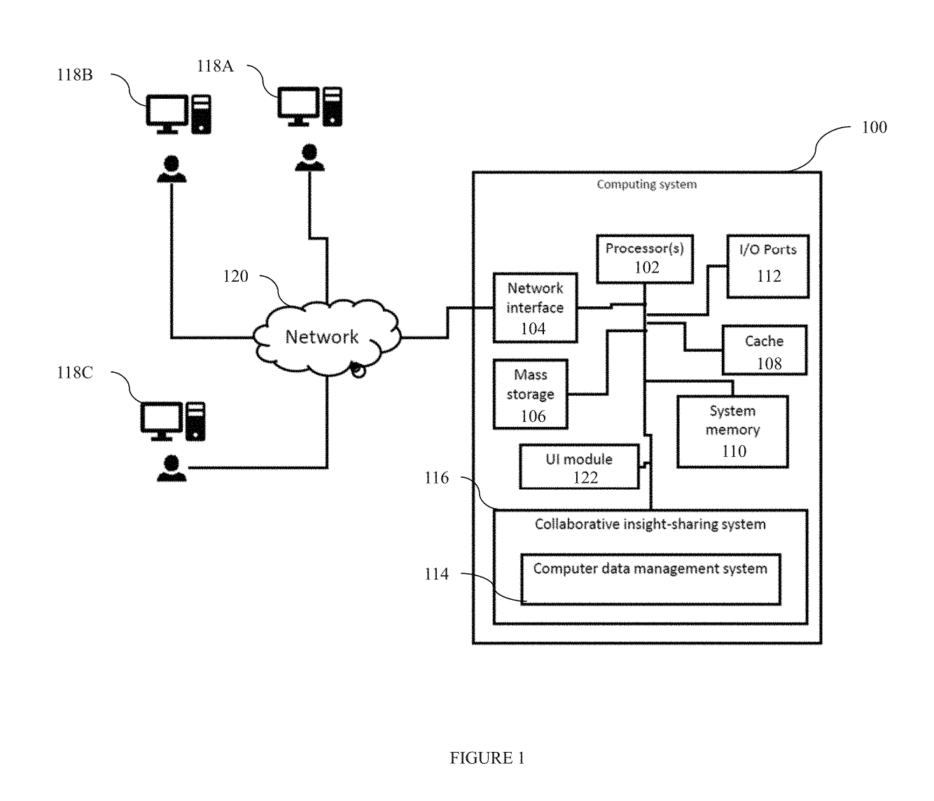

FIG. 1 depicts and illustrative embodiment of a schematic of a computing system 100. Computing system 100 one or more processors 102, a network interface 104, mass storage 106, cache 108, system memory 110, I/O ports 112 and a computer data management system 114. Computer data management system 114 is depicted here as being integrated within collaborative insight-sharing system 116.

Network interface 104 communicates with computing devices 118A-118C over a network 120. Network 120 can be the Internet, a virtual private network, corporate network, or any network known in the art for enabling computer networking across a collection of computer users. In the depicted embodiment, computing devices 118A-C are depicted as portable computers. It is contemplated that portable computers can include, but are not limited to, tablets, smartphones, laptops, wearable devices, or any computing device known in the art that is capable of communicating over network 120. It is further contemplated that users using computing devices 118A-C interact with insight data objects through UI module 122 of computing system 100.

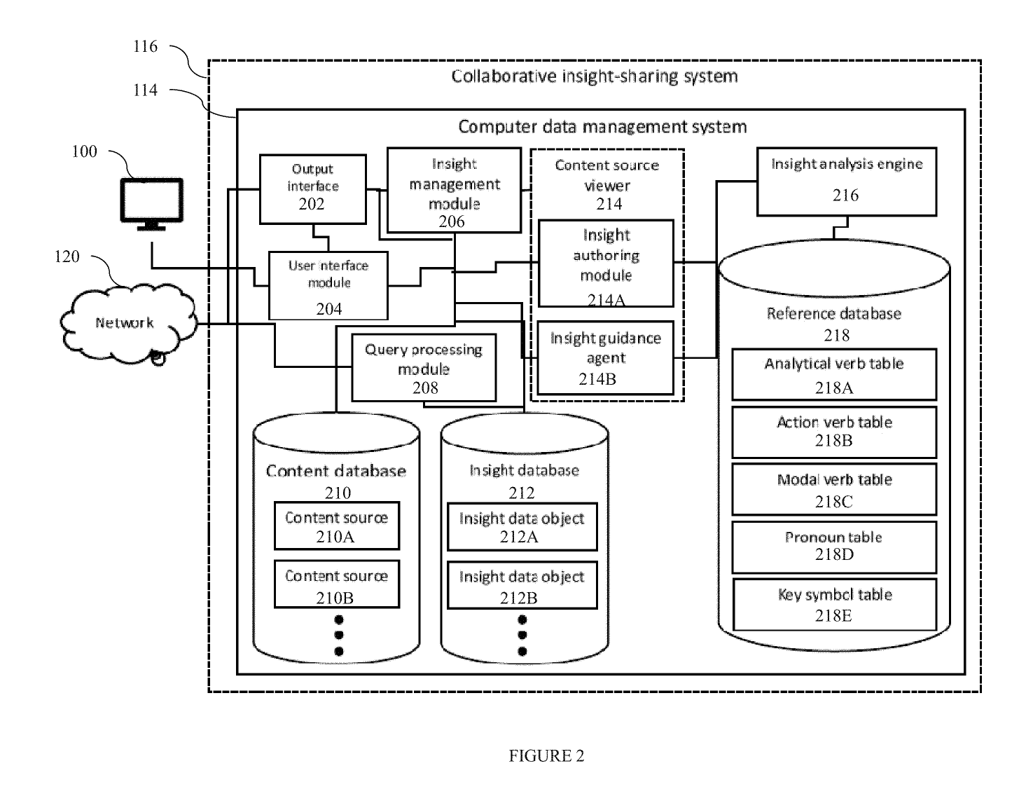

FIG. 2 depicts a block diagram of collaborative insight-sharing system 116 incorporating computer data management system 114. Computer data management system 114 is shown as including output interface 202, user interface module 204, insight management module 206, query processing module 208, content database 210, insight database 212, content source viewer 214, and insight analysis engine 216 connected to reference database 218.

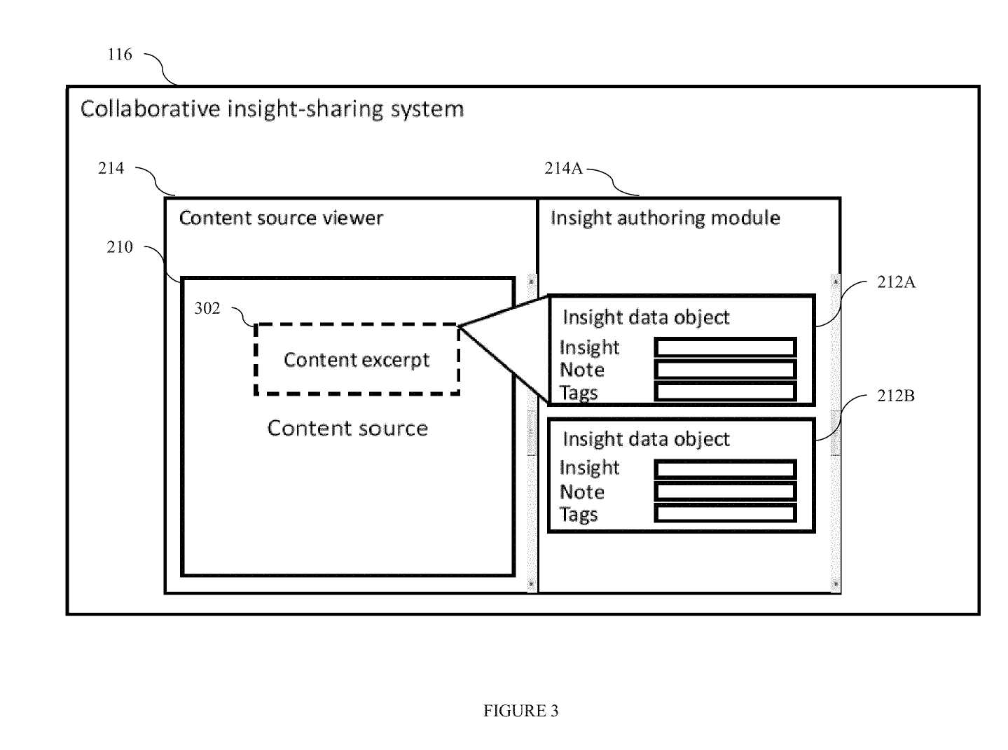

In the depicted embodiment, content source viewer 214 comprises insight authoring module 214A that receives insight data objects 212A-B, as well as insight guidance agent 214B that provides guidance to insight authors with regard to the indexing and retrieval of insight data objects 212A-B. Content database 210 contains content sources 210A-B and content excerpt 302 that are consumed by insight authors via insight authoring module 214A through content source viewer 214 (shown in more detail in FIG. 3), and can trigger the formation of insight data objects 212A-B, which are stored in insight database 212. In a preferred embodiment, reference database 218 comprises analytical verb table 218A, action verb table 218B, modal verb table 218C, pronoun table 218D, and key symbol table 218E.

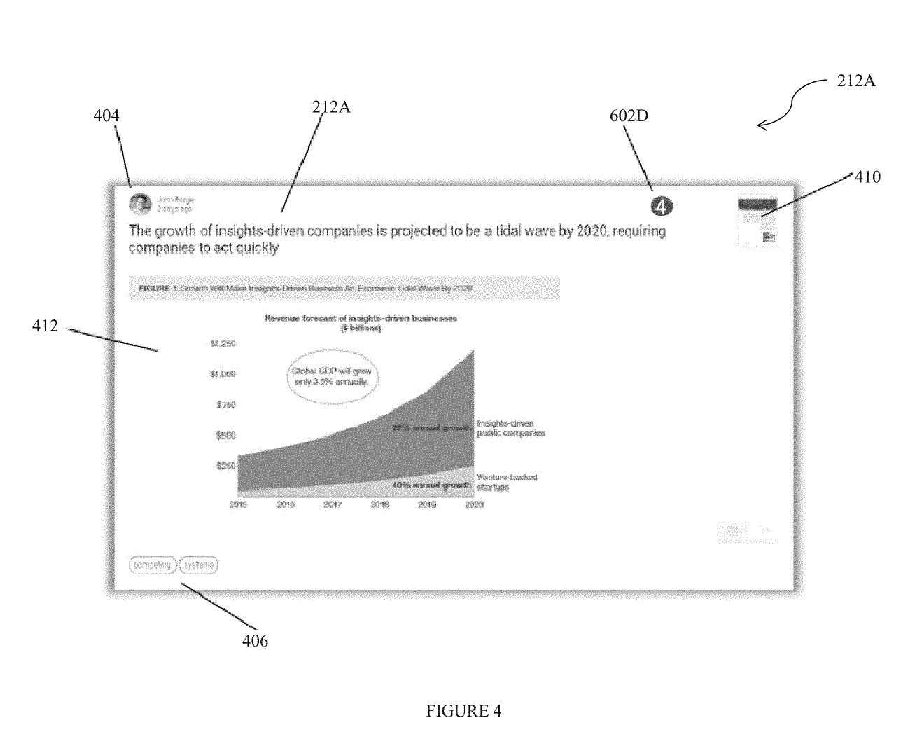

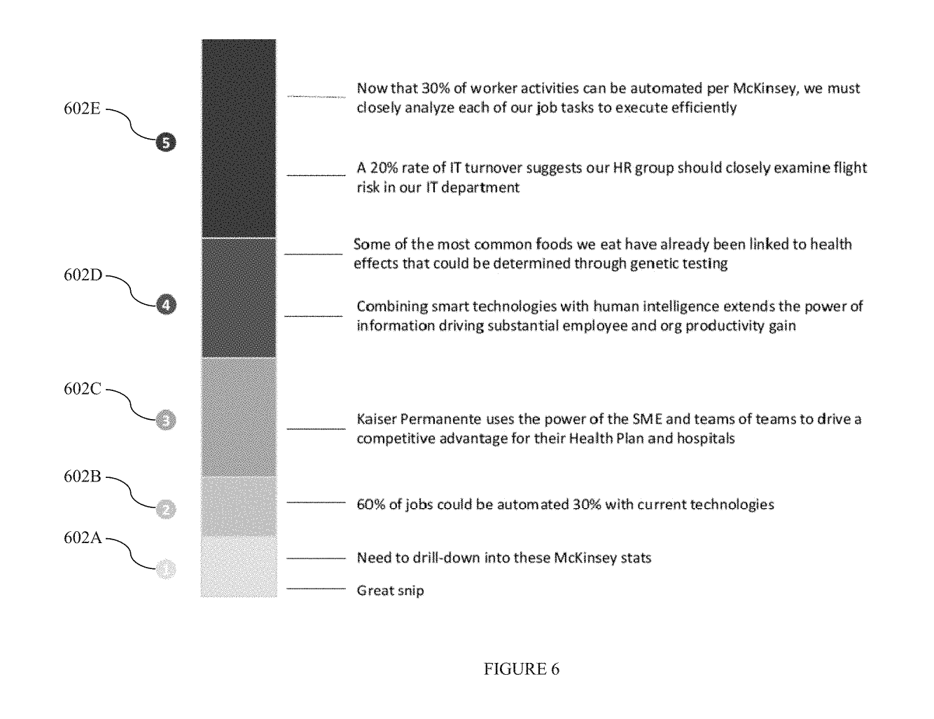

FIG. 4 shows an illustrative example of an insight data object 212A, here shown as being linked to content excerpt 412 and content source 410. Insight data object 212A can further include an insight author 404, tags 406, and an insight actionability measure 602D (shown in more detail in FIG. 6). An insight data object 212A can be linked to content excerpt 412 selected from content source by an insight author.

Content excerpt 412 can comprise an image of a selection made by an insight author from content source 410. In a preferred embodiment, content excerpt 412 is a separate entity from content source 410 from which content excerpt 412 is selected. In some embodiments, content excerpt 412 includes both the image of the selection from content source 410, as well as text from content source 410 that is associated with the image. For example, text from content source 410 can be text derived from the image via character recognition technologies such as optical character recognition (OCR) or captured as part of the user selection process based on the features offered by the software used to view content source 410 at the time content excerpt 412 is selected.

Content sources 410 comprise a form of digital content, and can include a digital document, web page, e-Book, blog, picture, video, audio or other form of digital content known in the art. In a preferred embodiment, content excerpts 412 are linked to content sources 410.

Additional embodiments of insight data objects 212A-B, their associations and interactions, and examples of how they are created are described in: (1) co-owned U.S. Pat. No. 9,705,835 B2 entitled “Collaboration Management Systems”, granted Jul. 11, 2017 wherein they are referred to as collaboration objects, and/or (2) as described in co-owned U.S. Pat. No. 9,613,136 B2 entitled “Assertion Quality Assessment and Management System”, granted Apr. 4, 2017, wherein they are referred to as assertion objects; and/or (3) co-owned U.S. Pat. No. 9,443,098 B2 entitled “Metadata Management System”, granted Sep. 13, 2016, wherein they are referred to as metadata objects.

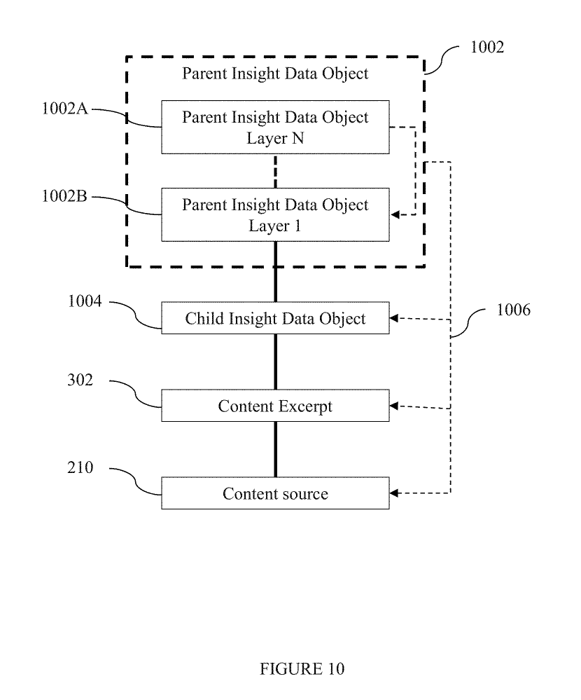

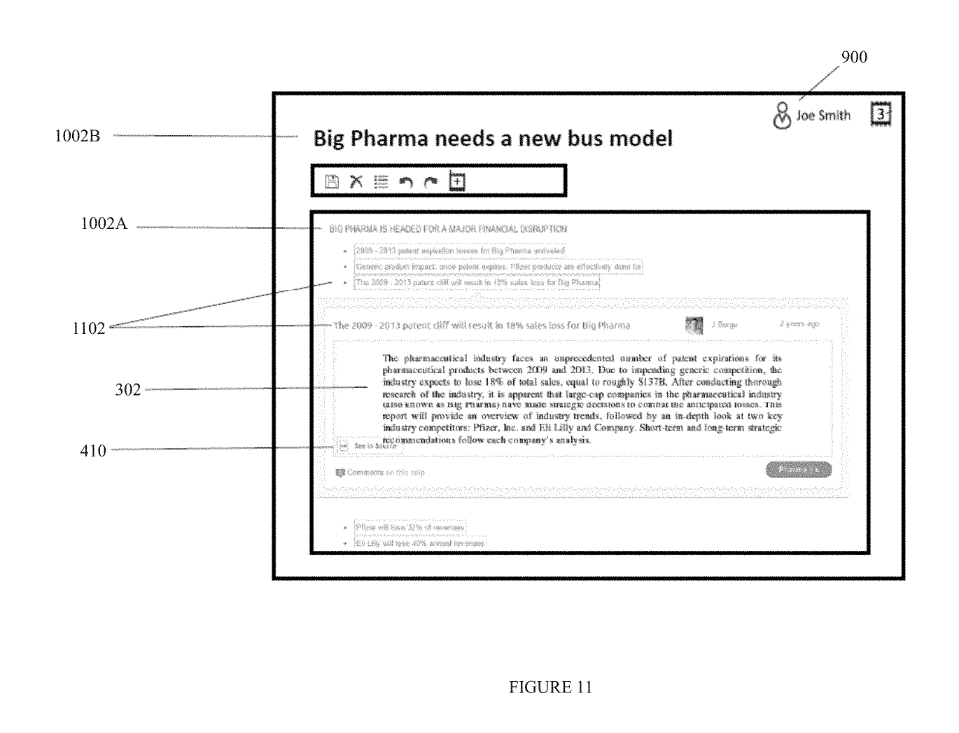

As shown in FIG. 10, in the preferred embodiment insight data objects 212A-B incorporate a multi-layer data structure, wherein successive layers are connected by verification links 1006. As shown in FIGS. 10 and 11, insight data objects 212A-B can also exist as parent insight data objects 1002 which link to child insight data objects 1004.

Parent insight data objects 1002 represent digital work-product created by an insight author. For example, parent insight data objects 1002 can include, but are not limited to, insight author conclusions, points, thoughts, ideas, findings and organizational structures related to insight data objects 212A-B processed by an insight author.

Parent insight data objects 1002 comprise digital files. For example, parent insight data objects 1002 and can include bulleted or numbered lists, a hierarchical structure (e.g. outline), narrative paragraph(s) of text, linked or embedded pictures, video files, audio files or other document files. In some embodiments, parent insight data objects 1002 further can include one or more child insight data objects 1004 referenced within the parent insight data object 1002, as shown in FIG. 11.

FIG. 11 further illustrates an example of an insight authoring module 214A, here shown for a parent insight object 1002, which enables insight authors to view parent insight data objects 1002 as well as author them. In the depicted embodiment, insight authoring module 214A comprises word processing functionality. For example, insight authoring module 214A can be selected from a group comprising a rich text editor, an HTML editor, a word processor, a presentation-authoring, a blog, and a wiki authoring system or any other means known in the art for authoring and editing digital content.

Additional embodiments of parent insight data objects 1002, their associations and interactions, and examples of how they are created are described in co-owned U.S. Pat. No. 9,773,000 B2 entitled “Knowledge Object and Collaboration Management System”, granted Sep. 26, 2017, wherein they are referred to as point objects.

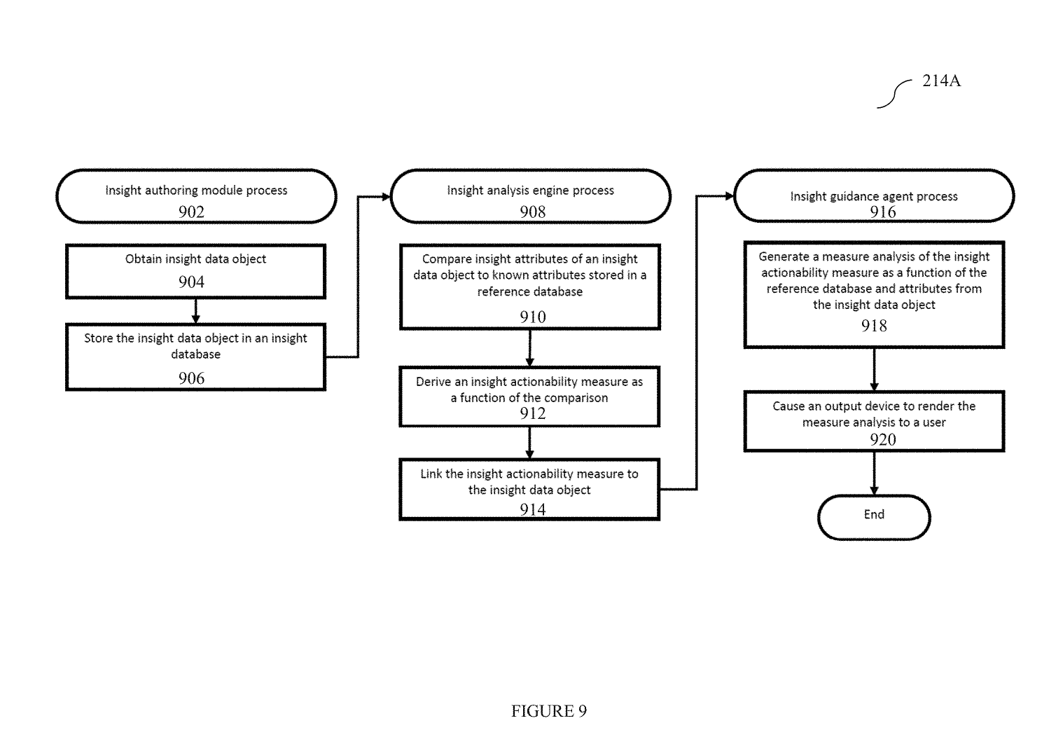

In operation, as shown in FIG. 9, an insight authoring module 214A obtains insight data object 212A and stores insight data object 212A in insight database 212. Insight analysis engine 216 compares insight attributes of insight data object 212A-B to known attributes stored in reference database 218, derive an insight actionability measure 602A-E as a function of the comparison, and link insight actionability measure 602A-E to insight data object 212A. The link can be in the form of metadata, a URL reference, a hyperlink or any other way known in the art to link data objects. Insight guidance agent 212B can then generate a measure analysis of insight actionability measures 602A-E and cause an output device to render the measure analysis to the user via output interface 202.

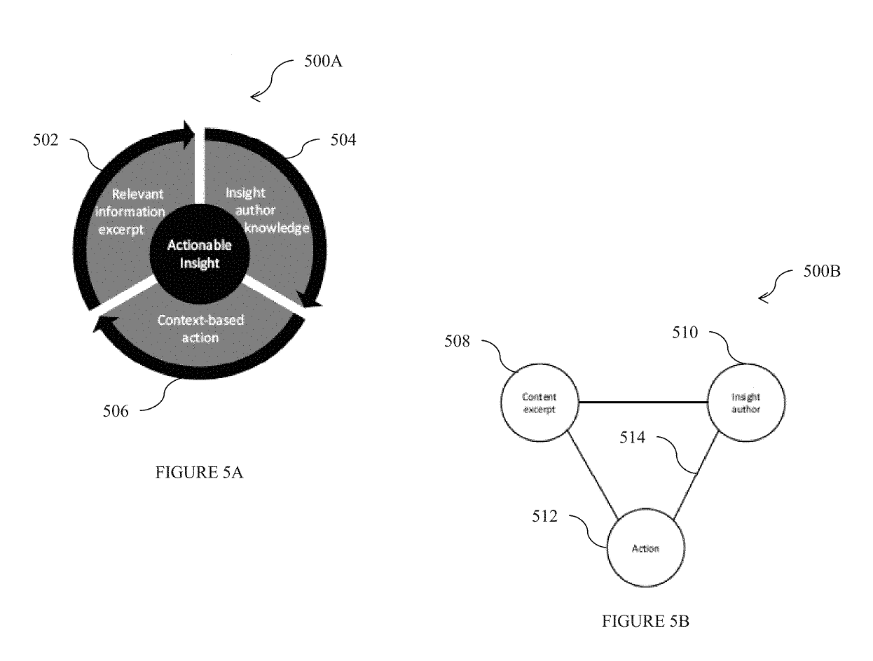

FIG. 5A depicts a first embodiment 500A of insight actionability measure 602A-E is a function of content 502 consumed by an insight author the knowledge of insight author 504 and actions 506 that can be appropriate given the context of insight author.

As shown in FIG. 5B depicts a second embodiment 500B, in which each of the aspects in FIG. 5A can be represented as nodes 508, 510, and 512 in an insight data object graph with the edges representing the relationship between nodes 508, 510, and 512, and edge strength 514. Edge strength 514 represents the strength of the relationship between two nodes as captured in an insight data object 212A received by insight authoring module 214A.

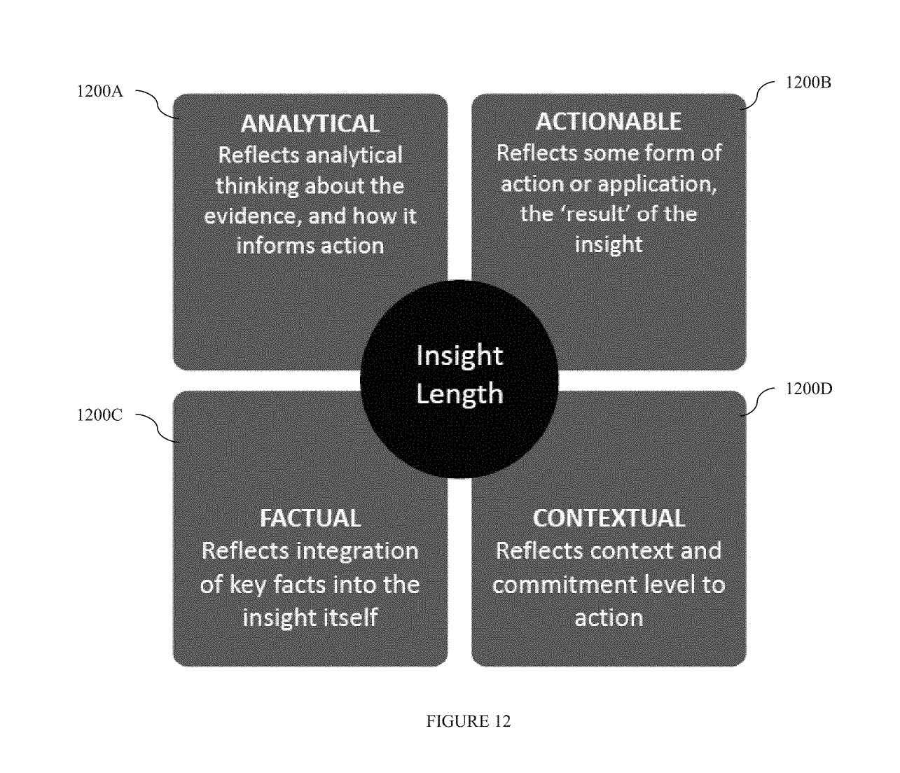

FIG. 12 illustrates one embodiment of deriving insight actionability measures 602A-E, here depicting core components 1200A-D of a keyword scoring algorithm based on keyword tables and insight length.

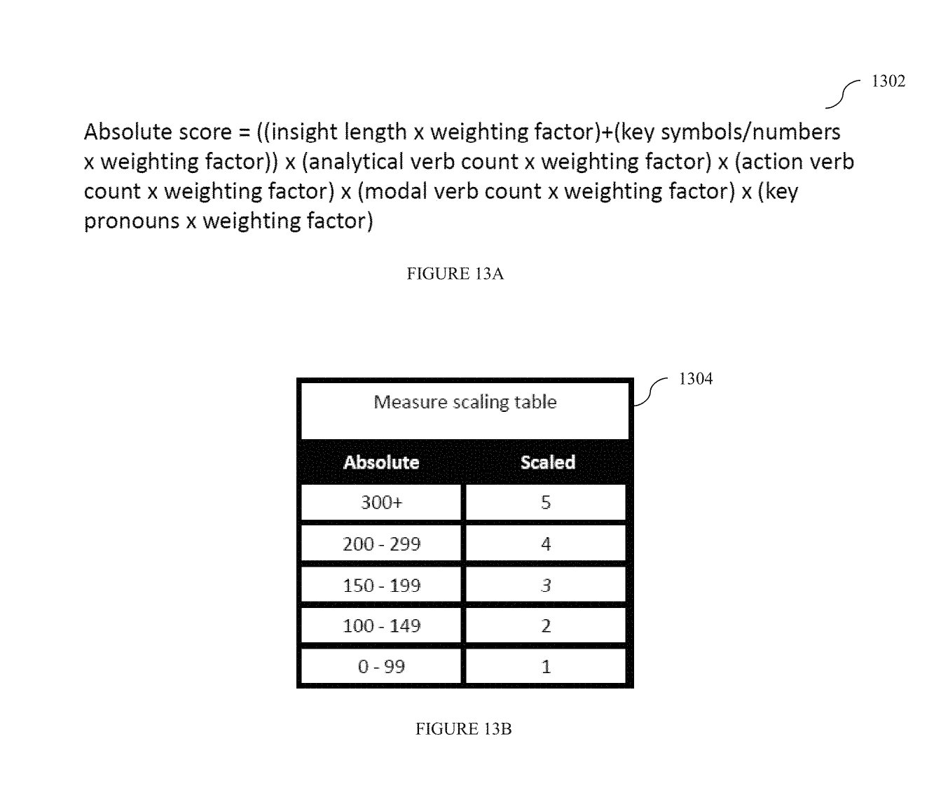

FIG. 13a illustrates an embodiment of scoring algorithm 1302 used by the insight analysis engine 216 to derive an insight actionability measure 602A-E in the form of an absolute score. Scoring algorithm 1302 is shown as using core components 1200A-D depicted in FIG. 12 as well as weighting factors. Weighting factors can be integers, fractions, functions or any form of mathematical multiplier or function.

FIG. 13b depicts an embodiment in which the absolute score can be converted to a scaled score using a measure scaling table 1304.

FIG. 6 shows depicts an exemplary embodiment in which actionability measures 602A-E are presented as scaled scores for a set of insight data objects 212A-B.

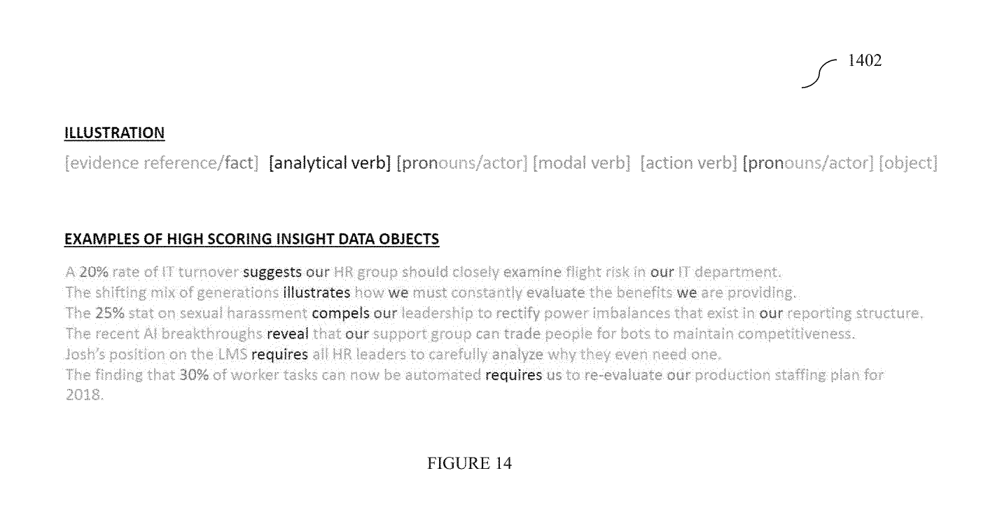

FIG. 14 depicts an illustration of the words that the insight analysis engine 216 searches for in executing the algorithm FIG. 14 also depicts examples of high-scoring insight data objects 1402B.

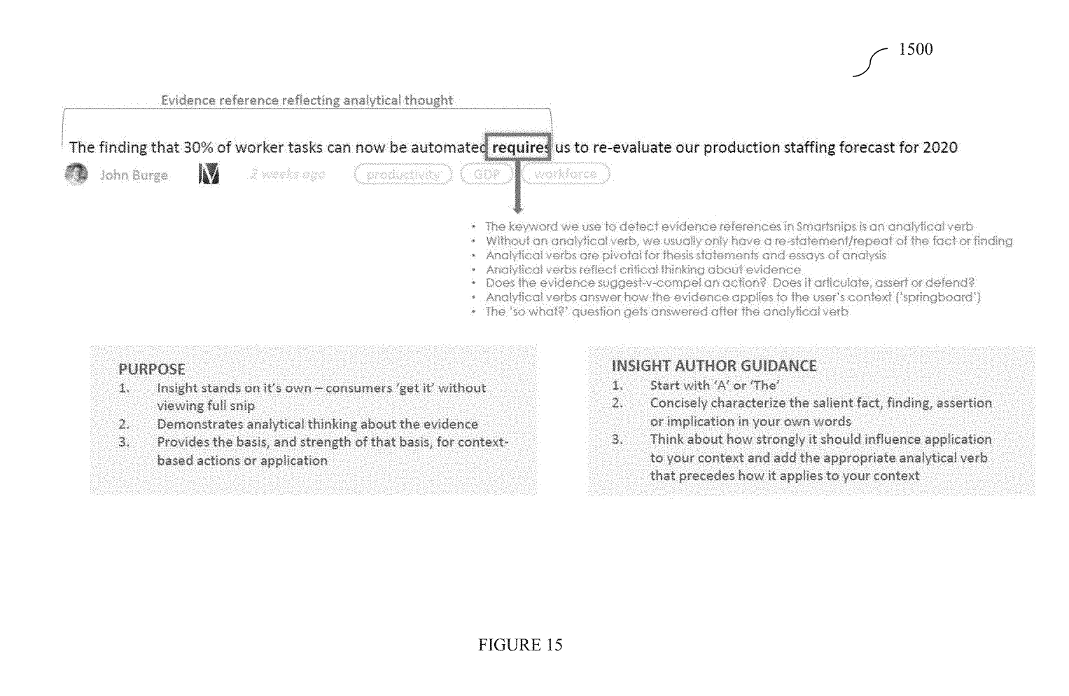

FIGS. 15-18 detail core components 1200A-D which, in addition to insight length, factor into insight actionability measures 602A-E and rely on key word or symbol matches: analytical, factual, actionable and contextual.

FIG. 15 depicts one embodiment of analytical component 1500. Insight analysis engine 216 examines an insight data object 212A to see if it contains one or more analytical verbs which match analytical verbs stored in analytical verb table 218A in reference database 218 as shown in FIG. 2.

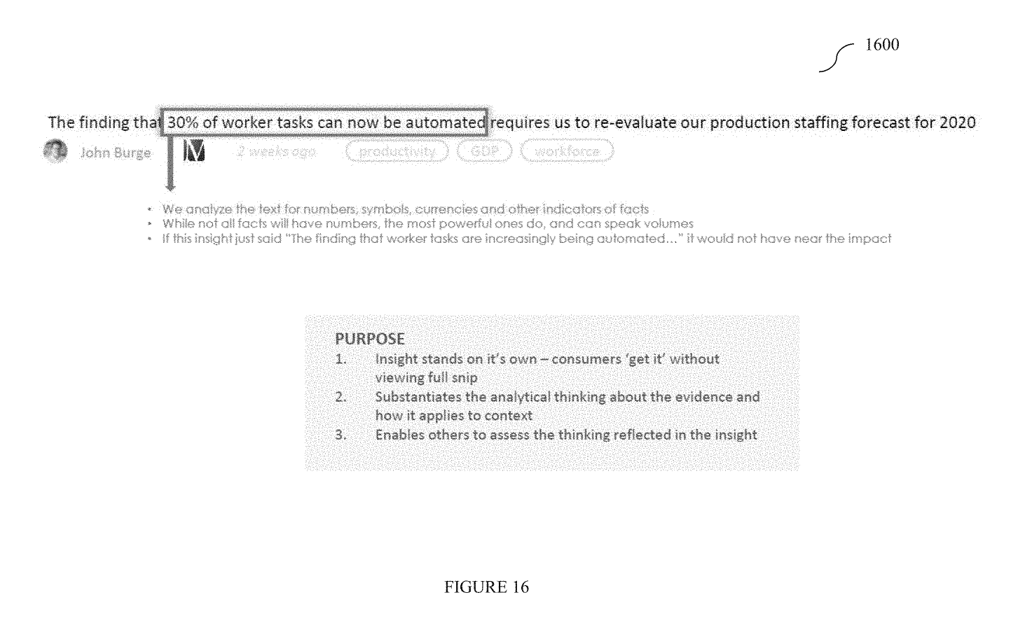

FIG. 16 depicts one embodiment of factual component 1600. Insight analysis engine 216 examines insight data object 212A to see if it contains one or more numbers or key symbols which match key symbols or numbers stored in the key symbol table 218E in the reference database 218 as shown in FIG. 2.

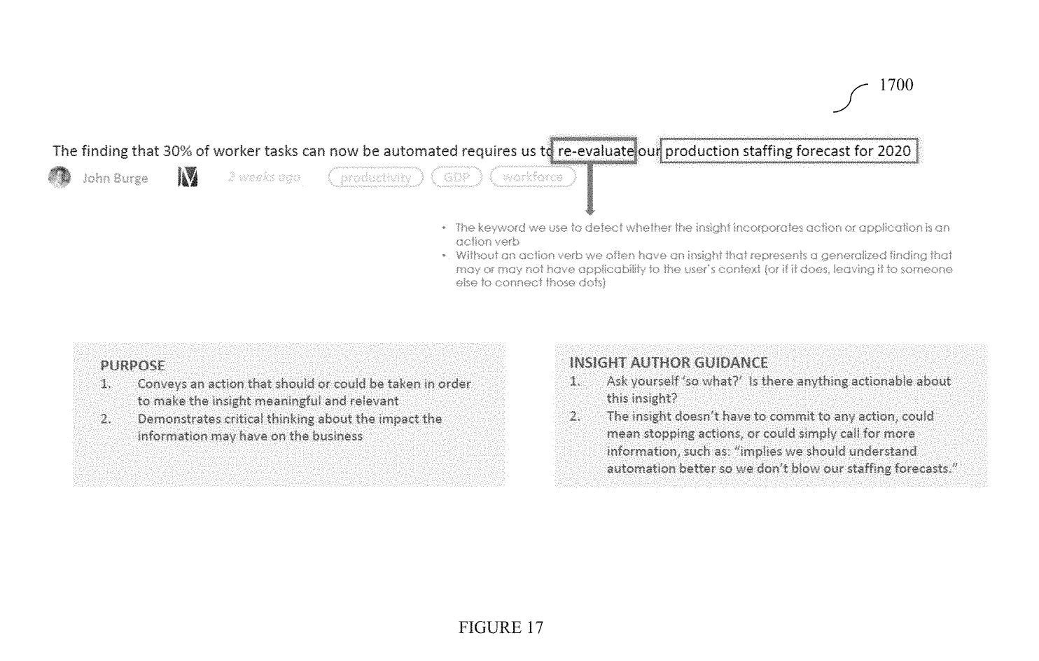

FIG. 17 depicts one embodiment of actionable component 1700. Insight analysis engine 216 examines an insight data object 212A to see if it contains one or more action verbs which match action verbs stored in action verb table 218B in reference database 218 as shown in FIG. 2.

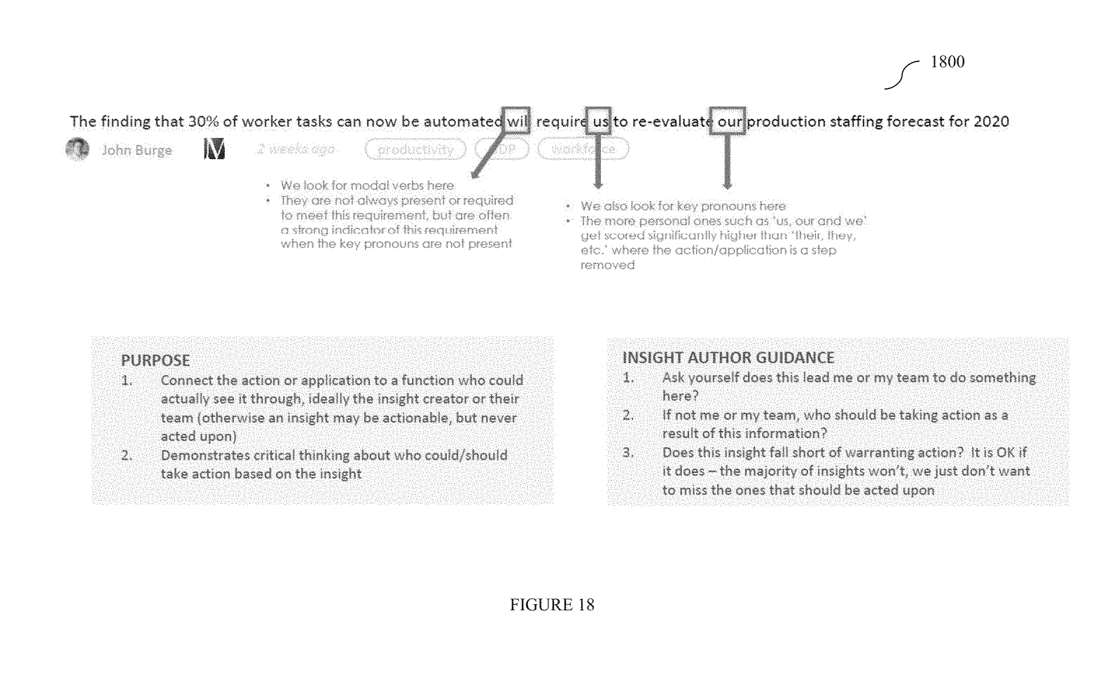

FIG. 18 details contextual component 1800. Insight analysis engine 216 will examine insight data object 212A to see if it contains one or more modal verbs which match modal verbs stored in modal verb table 218C in reference database 218 as shown in FIG. 2 and/or pronouns which match pronouns stored in pronoun table 218D in reference database 218 as shown in FIG. 2. Below is an example of an algorithm that can be executed by insight analysis engine 216:

| | |
|---|---|
| /* | Function to determine the score for a given Insight |
| * | Accepts a string argument, insight |
| */ | Returns a number representing its score |

function determineInsightScore(insight) {

// Calculate the length component
insightLength = numberOfCharacters(insight);
lengthWeightFactor = retrieveLengthWeightFactor( );
lengthComponent = insightLength × insightWeightFactor;
// Calculate the Analytical component
analyticalKeywords = retrieveAnalyticalKeywords( );
numberOfAnalyticalKeywords = 0;
for each analyticalKeyword in analyticalKeywords {

currentNumberOfAnalyticalKeywords =

numberOfKeywordInstancesInInsight(insight, analyticalKeyword);

numberOfAnalyticalKeywords = numberOfAnalyticalKeywords +

currentNumberOfAnalyticalKeywords;

}
analyticalWeightFactor = retrieveAnalyticalWeightFactor( );
analyticalComponent = numberOfAnalyticalKeywords × analyticalWeightFactor;
// Calculate the Actionable component
actionableKeywords = retrieveActionableKeywords( );
numberOfActionableKeywords = 0;
for each actionableKeyword in actionableKeywords {

currentNumberOfActionableKeywords =

numberOfKeywordInstancesInInsight(insight, actionableKeyword);

numberOfActionableKeywords = numberOfActionableKeywords +

currentNumberOfActionableKeywords;

}
actionableWeightFactor = retrieveActionableWeightFactor( );
actionableComponent = numberOfActionableKeywords × actionableWeightFactor;
// Calculate the Factual component
factualKeywords = retrieveFactualKeywords( );
numberOfFactualKeywords = 0;
for each factualKeyword in factualKeywords {

currentNumberOfFactualKeywords =

numberOfKeywordInstancesInInsight(insight, factualKeyword);

numberOfFactualKeywords = numberOfFactualKeywords +

currentNumberOfFactualKeywords;

}
factualWeightFactor = retrieveFactualWeightFactor( );
factualComponent = numberOfFactualKeywords × factualWeightFactor;
// Calculate the Contextual component
contextualKeywords = retrieveContextualKeywords( );
numberOfContextualKeywords = 0;
for each contextualKeyword in contextualKeywords {

currentNumberOfContextualKeywords =

numberOfKeywordInstancesInInsight(insight, contextualKeyword);

numberOfContextualKeywords = numberOfContextualKeywords +

currentNumberOfContextualKeywords;

}
contextualWeightFactor = retrieveContextualWeightFactor( );
contextualComponent = numberOfContextualKeywords × contextualWeightFactor;
// Calculate and return insight Score
insightScore = lengthComponent + analyticalComponent + actionableComponent +

factualComponent + contextualComponent;

return insightScore;

}

Those skilled in the art can appreciate that the function ‘numberOfKeywordInstancesInInsight’ can be executed to determine the number of keyword matches in a variety of ways, including, for example, RegEx, parse string, and word-by-word comparison.

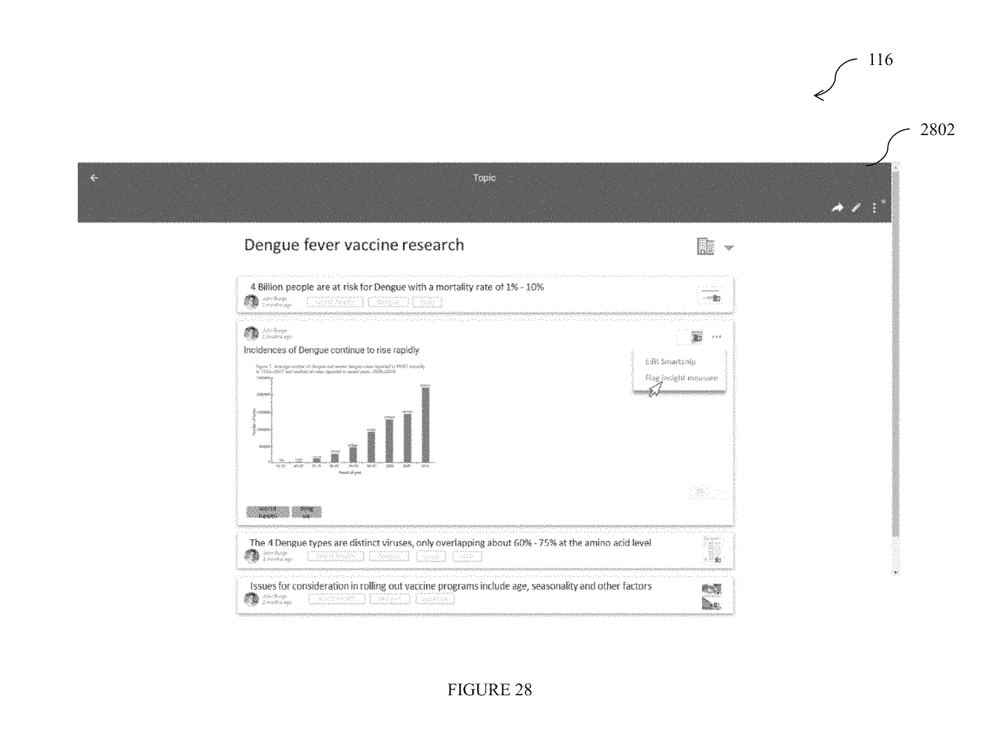

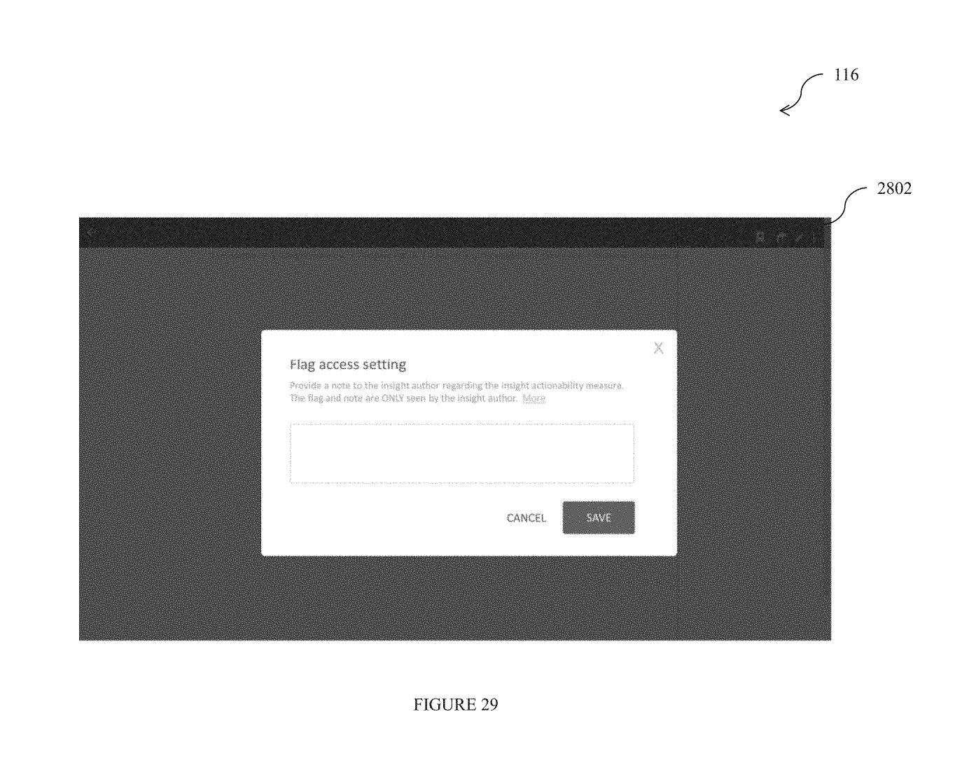

The algorithm and keyword tables in reference database 218 (shown in FIG. 2) can be improved over time based on input from other users consuming insight data objects 212A-B associated with collaborative insight-sharing system 116. FIG. 28 illustrates a user feedback mechanism 1200A-D associated with collaborative insight-sharing system 116, and FIG. 29 illustrates use of user feedback mechanism 1200A-D in receiving feedback about insight actionability measures 602A-E.

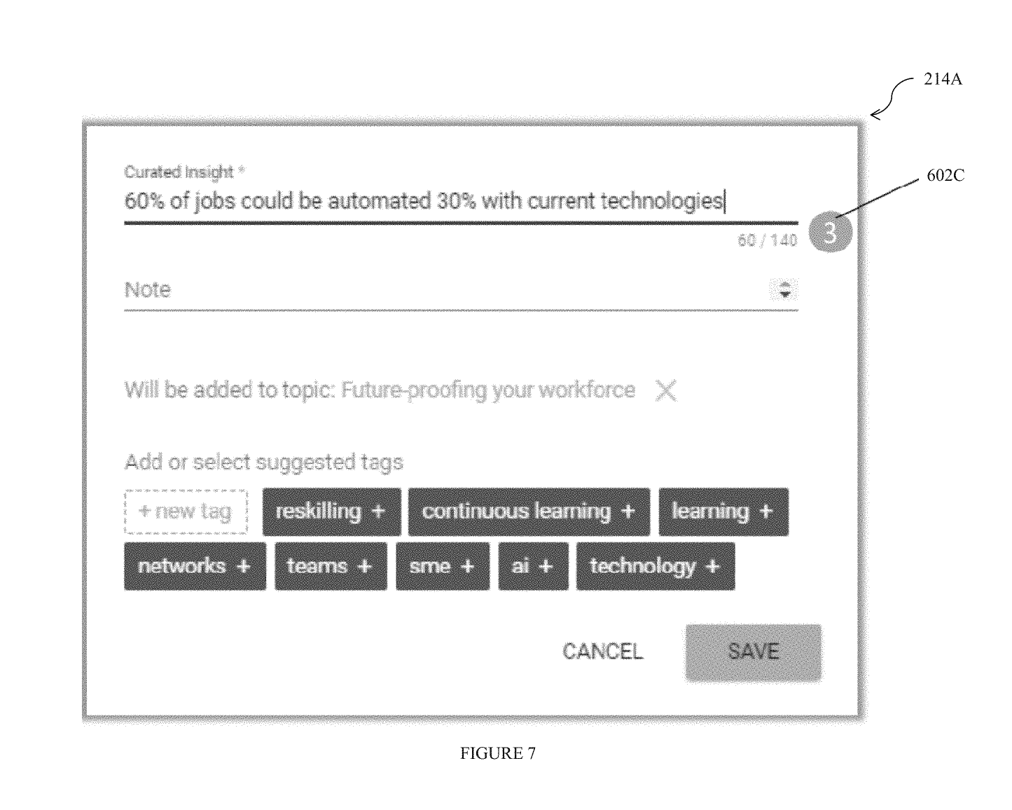

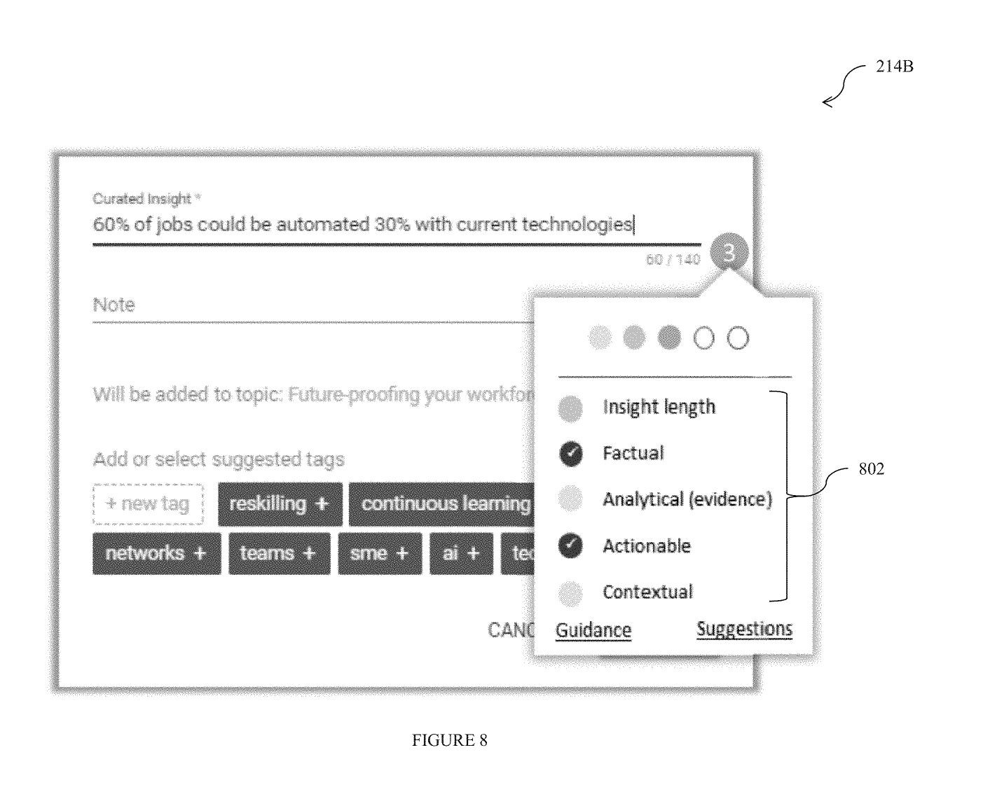

FIG. 7 depicts an insight authoring module 214A configured to receive an insight data object 212A from an insight author, here shown with insight actionability measure 602A-E presented to insight author. FIG. 8 depicts the user view of insight guidance agent 214B. Insight guidance agent 214B presents a measure analysis to insight author, enabling an insight author to see how an insight data object they created scored against the core components 1200A-D being used by an algorithm.

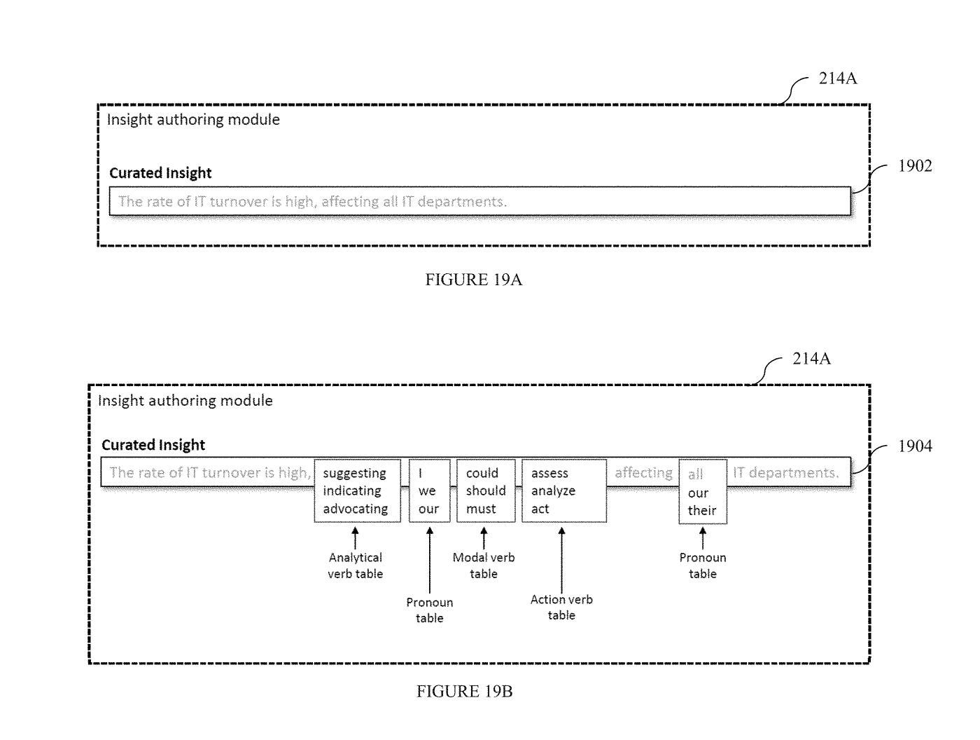

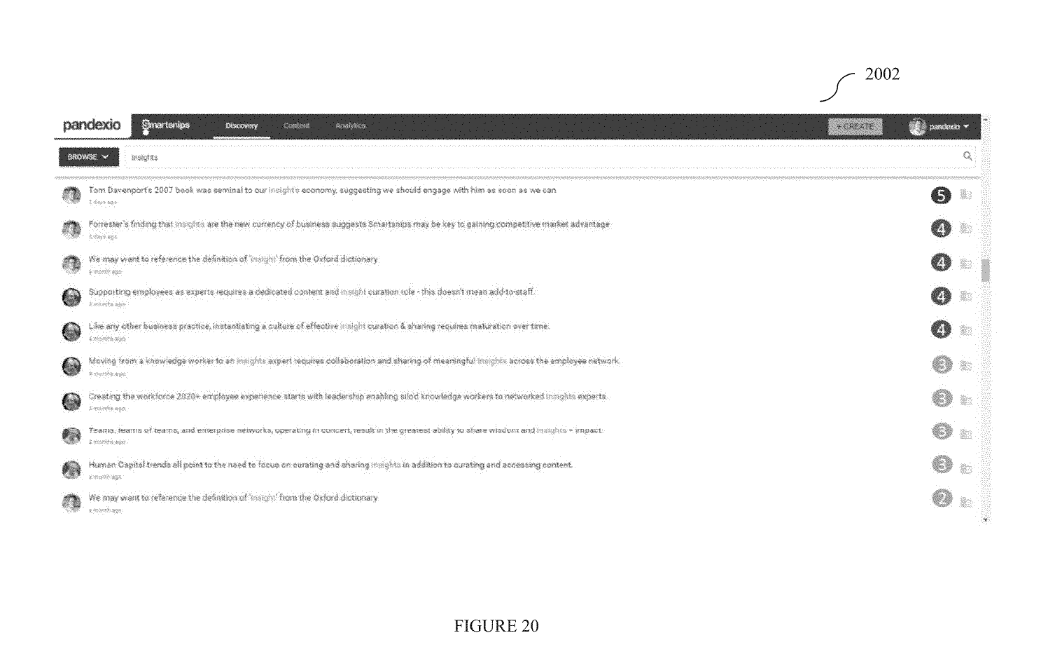

FIGS. 19a and 19b depict an alternative embodiment of insight guidance agent 214B, here shown providing more detailed feedback to an insight author in the form of keywords that are missing from insight data object 212A, as well as suggested alternative words for insight data object 212A that would result in insight analysis engine 216 generating a higher insight actionability measure 602A-E. FIG. 20 depicts user interface 2002 for receiving user input and presenting search results.

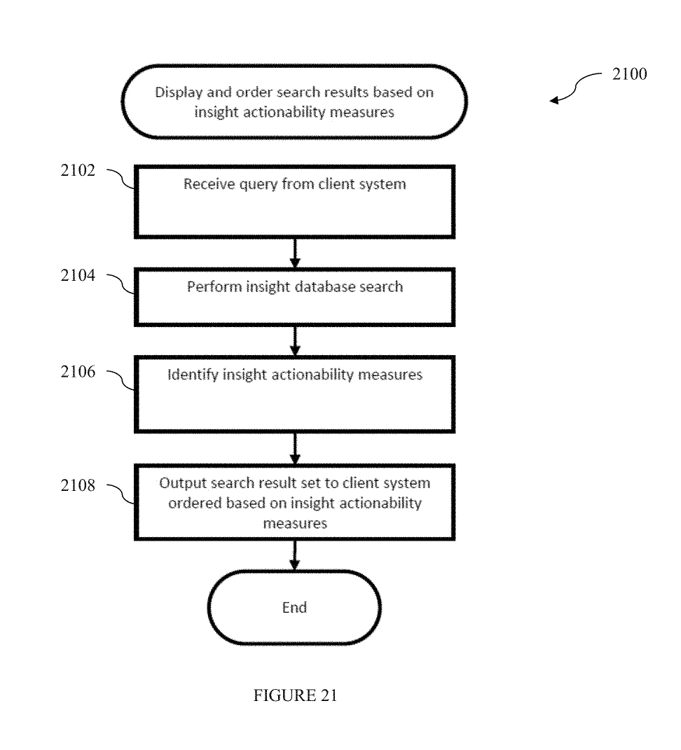

FIG. 21 is a process diagram illustrating search process 2100 against a database of insight data objects 212A-B that incorporate insight actionability measures 602A-E. Insight analysis engine 216 receives a query from a client system (step 2102). Insight analysis engine 216 performs an insight database search (step 2104). Insight analysis engine 216 then identifies insight actionability measures 602A-E (step 2106). Finally, insight analysis engine 216 outputs a search result set to a client system that is ordered based on the actionability measures 602A-E, as shown in FIG. 20.

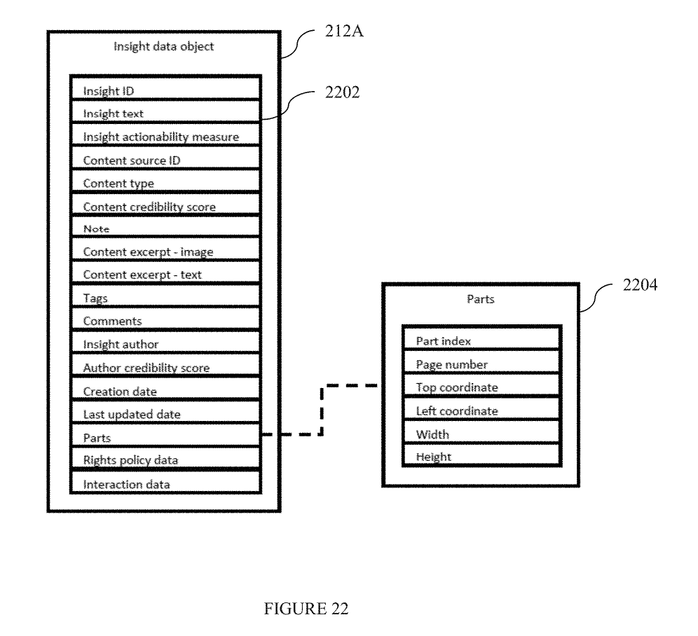

Alternatively, FIG. 22 depicts insight data object 212A which includes additional attributes 2202 for use in ordering a search results set. Additional attributes 2202 can include, but are not limited to, content credibility scores, author credibility scores and interaction data. Additionally, insight data object 212A can also comprise sub-attributes 2204 that further hone into characteristics of each attribute in additional attributes 2202.

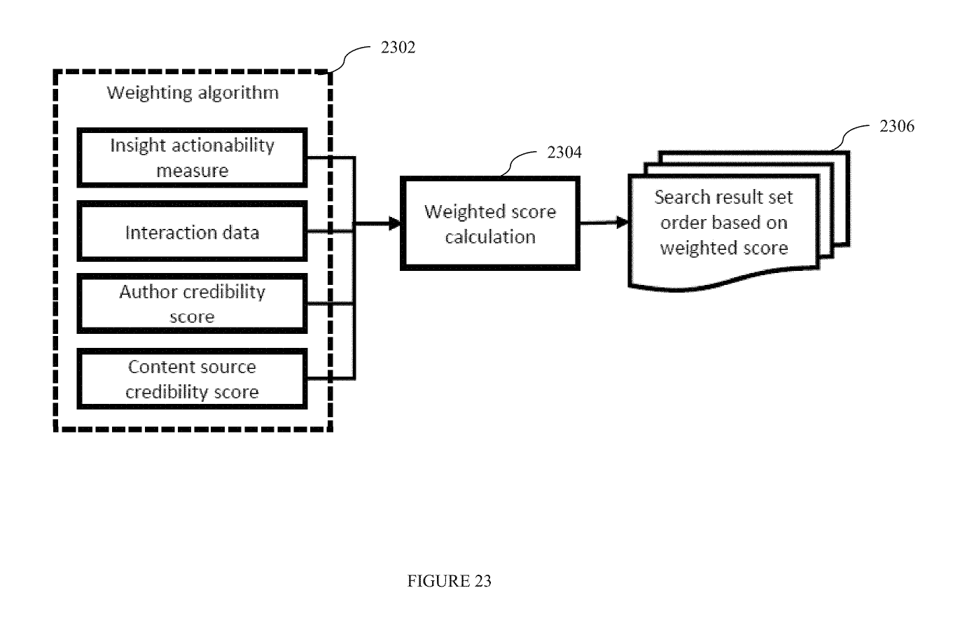

FIG. 23 depicts weighting algorithm 2302 used to generate weighting score 2304 using additional attributes 2202 in conjunction with insight actionability measures 602A-E, thereby enabling a search result set 2306 to be ordered based on a weighted score.

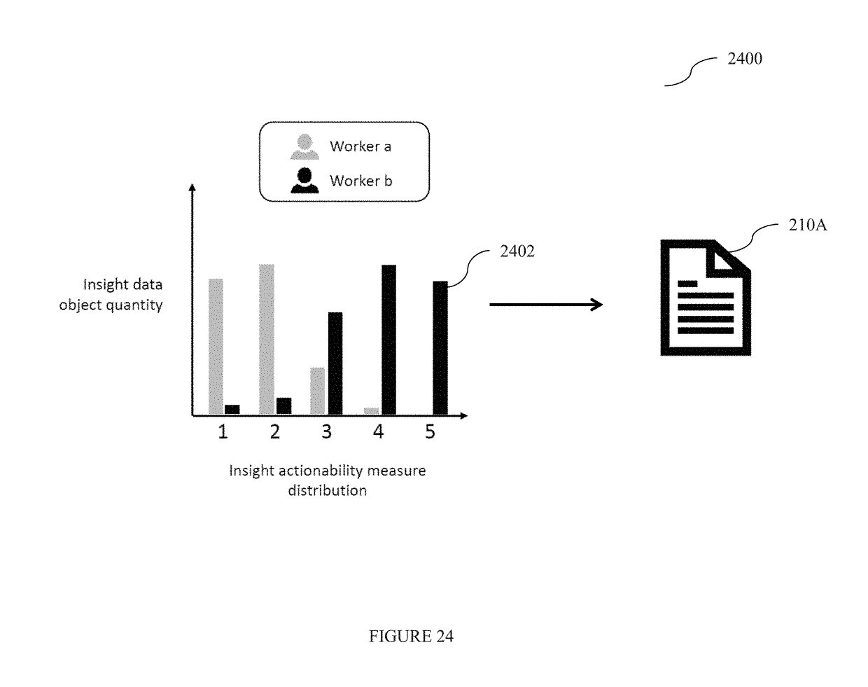

FIGS. 24-27 illustrate the use of insight actionability measures 602A-E for mapping insight data objects 212A-B to one or more knowledge levels.

FIG. 24 depicts the classification of insight data objects 212A-B into general knowledge level output 2402 based on content source 210A.

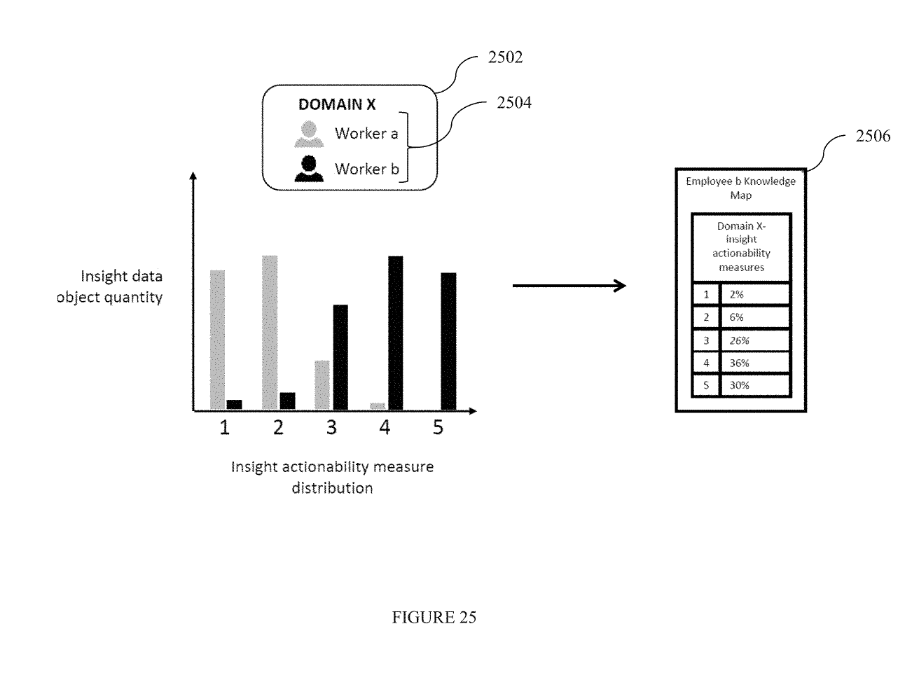

FIG. 25 depicts the classification of insight data objects 212A-B into a domain-specific knowledge level output 2506 for specific workers 2504 belonging to a common domain 2502.

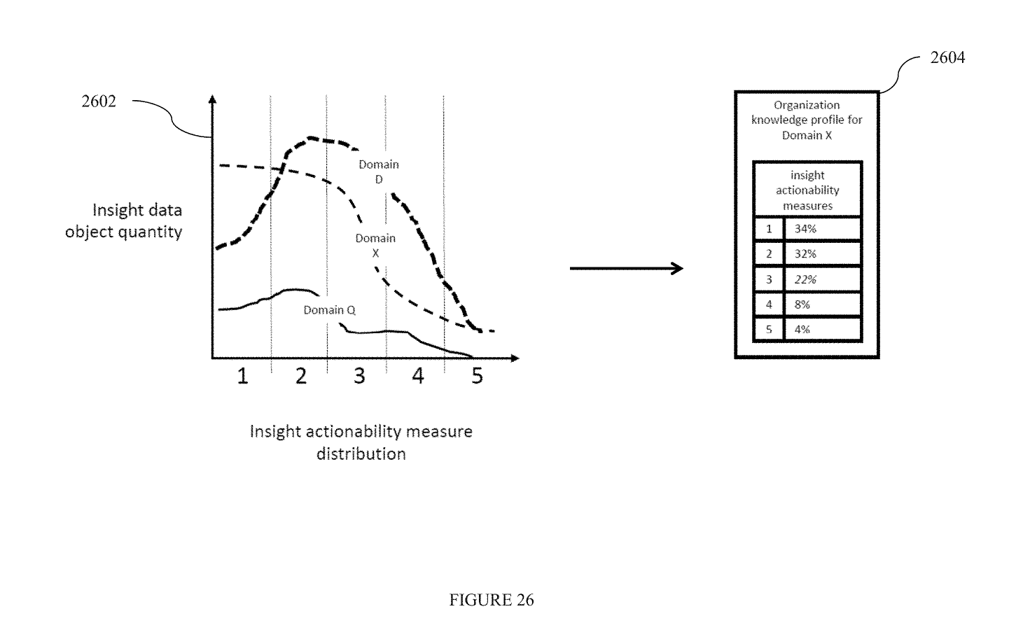

FIG. 26 depicts the classification of insight data objects 212A-B into an aggregate knowledge level output 2602 for a domain for an aggregate grouping of workers. Insight analysis engine 216 then aggregates knowledge level output 2602 to produce analytical output 2604.

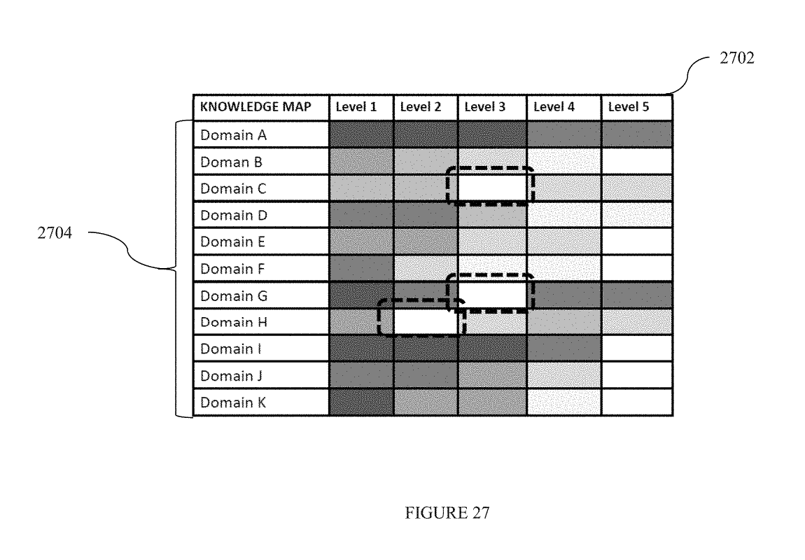

FIG. 27 depicts knowledge map 2702 of insight data objects 212A-B, such as insight data object 212A, classified into knowledge levels across a set of domains 2704 relevant to an organization.

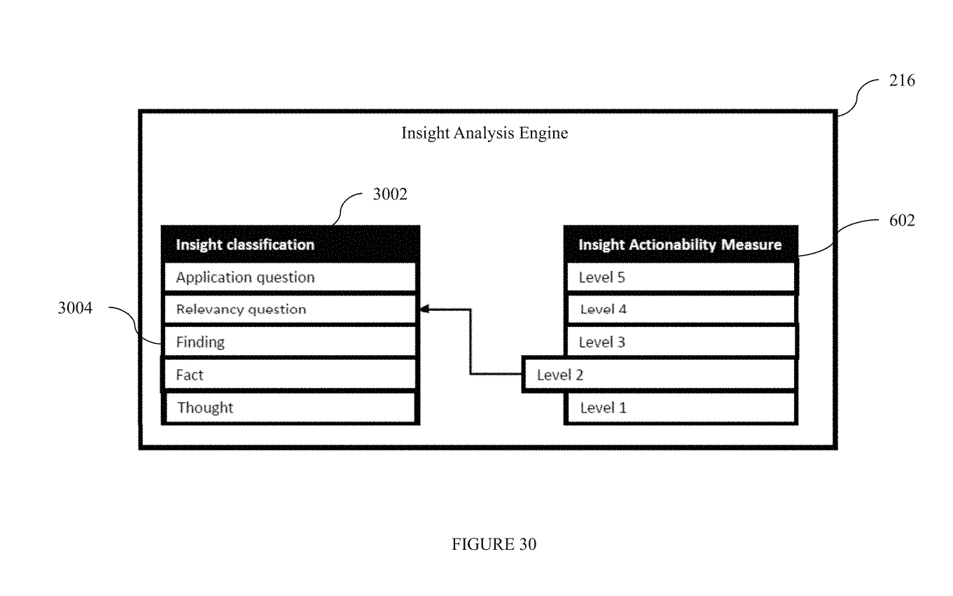

FIG. 30 depicts an illustrative embodiment of insight classification 3002 associated with insight data object 212A into an insight type 3004 by insight analysis engine 216.

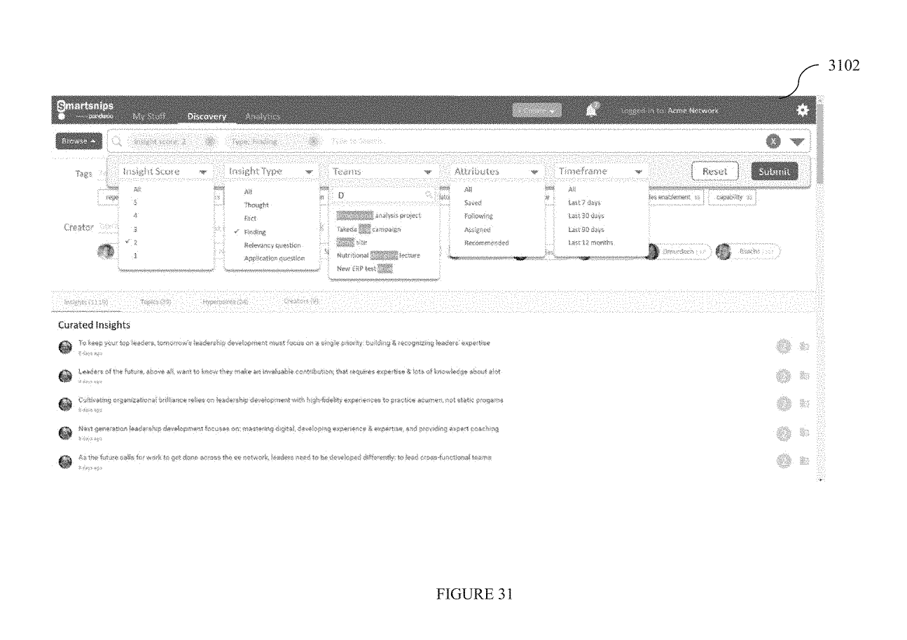

FIG. 31 depicts an illustrative embodiment of insight classification 3002 in which insight types 3004 can be used in filtering search results 3102.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of reducing steps to index and retrieve an insight data object, comprising:
obtaining the insight data object;
storing the insight data object in an insight database;
comparing insight attributes of the insight data object to known attributes stored in a reference database;
deriving an insight actionability measure as a function of the comparison;
linking the insight actionability measure to the insight data object;
generating a measure analysis of the insight actionability measure as a function of the reference database and the insight attributes of the insight data object; and
causing an output device to render the measure analysis to a user.

2. The method of claim 1, wherein the evidence data object comprises a content excerpt linked to a content source.

3. The method of claim 1, wherein the insight data object is a parent insight data object linked to one or more child insight data objects.

4. The method of claim 1, further comprising classifying the insight data object into a knowledge level for a domain.

5. The method of claim 1, further comprising classifying the insight data object into a knowledge level for a content source.

6. The method of claim 1, further comprising classifying an insight data object into an insight type.

7. The method of claim 1, further comprising weighing the results of a sentiment analysis in deriving an insight actionability measure.

8. The method of claim 1, further comprising suggesting keywords to an insight author from the reference database, wherein the keywords assist in deriving the insight actionability measure.

9. The method of claim 1, further comprising, identifying one or more missing word types that are missing from insight data object, wherein the one or more missing word types assist in deriving the insight actionability measure.

10. The method of claim 1, further comprising revising the insight actionability measure in response to changes to the insight data object.

11. The method of claim 1, further comprising executing an algorithm between words in the insight data object and words in a keyword table, wherein the algorithm is based on keyword matches.

12. The method of claim 2, further comprising deriving a statistical model that compares attributes of the insight data object to the insight attributes of other insight data objects stored in the insight database.

13. The method of claim 1, wherein the insight data object in the insight database are appended with user interaction data.

14. The method of claim 1, further comprising deriving the insight actionability measure using ontologies.

15. The method of claim 1, further comprising deriving the insight actionability measure using a rules-based expert system.
